(19) United States
(12) Patent Application Publication
(10) Pub. No.: US 2004/0163709 A1
(43) Pub. Date: Aug. 26, 2004

(54) Fluid swivel with cooling porting

(76) Inventors: Benton F. Baugh, Houston, TX (US); Alan Louis Baezner, Houston, TX (US); John Francis Bradford, Katy, TX (US)

Correspondence Address: Benton F. Baugh, 14626 Oak Bend, Houston, TX, 77079, US

(21) Appl. No.: 10/372,434

(22) Filed: Feb. 24, 2003

(51) Int. Cl. G05D 7/00

(52) U.S. Cl. 137/355.16

(57) ABSTRACT

A fluid swivel which will tend to generate heat by the sliding friction of the seals on the mandrel which has cooling through the central portion which has enhanced cooling by providing a greater heat transfer area in a restricted area than would be available from a common circular drilled hole.

### CROSS-REFERENCE TO RELATED APPLICATIONS

Patent application titled MULTI-CHANNEL HIGH PRESSURE SWIVEL filed on the same date.

### STATEMENT REGARDING FEDERALLY SPONSORED RESEARCH OR DEVELOPMENT: N/A

### INCORPORATION-BY-REFERENCE OF MATERIAL SUBMITTED ON A COMPACT DISK: N/A

### BACKGROUND OF THE INVENTION

The field of this invention is that of multi-port hydraulic swivels for the purpose of communicating high pressure liquids or gasses from a non-rotating location to a rotating location. The most common application is on the central shaft of a hose reel in which the central shaft of the reel rotates with the drum. The drum will be rotating as the hose is rolled out to its intended service. The pressure fluid supply to the reel will characteristically not be rotating, and therefore a rotating union will be required between the non-rotating fluid supply and the rotating main shaft of the reel drum.

The importance of this type swivel has greatly increased as the drilling of oil and gas wells has moved to deep offshore waters. Drilling contemporarily occurs in 8,000 to 10,000 feet of seawater. In lowering the drilling system to these depths and in lowering certain completion and testing equipment, continuous pressure contact is desired to be maintained between the surface and the subsea equipment being lowered and/or operated. In some cases operational pressure is required as the equipment is lowered. In other cases, maintaining pressure on the system is a safety consideration. If the operator releases the pressure, the hose will become disconnected from the heavy package being lowered and allow the hose to be recovered. This is especially important if the heavy package becomes stuck on lodged in deep water.

As greater depths are encountered and higher pressures are desired to be maintained as the reel and swivel are rotated. This higher pressure and the inherently higher number of rotations associated with deeper water depth cause specific problems with the swivels.

A first problem is that a high degree of wear tends to occur in soft seals which can be inserted into machined grooves in the inner or outer surface of the mating parts. If a harder seal can be utilized at the higher pressures, a better or more extended wear life can be provided. An opposing pair of seals can be installed in the end of the outer body to a stopping shoulder and followed by a threaded gland to act as the opposing shoulder. On the other end of the outer body a second set of seals can be inserted to the opposite side of the central shoulder and again followed by a gland. This configuration can be utilized for a single or dual channel swivel, but there are needs for triple and quadruple channel swivels which cannot be serviced in this manner as there are only two ends to the outer body.

A second problem is that the higher pressure and higher number of rotations generates heat. Heat generated on the outside of the seals disperses into the outer body which has progressively greater area as the distance moves away from the seals, and has a relatively large outer surface to dissipate the heat to the environment. The heat generated at the I.D. of the seal moves toward the centerline of the mandrel portion of the swivel, and literally runs into the heat generated on the opposite of the mandrel. The heat has no place to go, so it builds up to higher temperatures. The higher temperatures characteristically increase the friction, generating more heat at an even faster rate. In some cases we have seen, the heat gets so high in contemporary applications that the seals are actually cooked and fail.

### BRIEF SUMMARY OF THE INVENTION

The object of this invention is to provide a swivel which provide enhanced cooling for the removal of heat which is generated by sliding seal friction. A second object of the present invention is more surface area for heat transfer than would be available from a round hole of the same cross sectional area.

### BRIEF DESCRIPTION OF SEVERAL VIEWS OF THE DRAWINGS

FIG. 1 is a partial section thru a subsea blowout preventer stack and a view of a reel in which a swivel of this invention would be used.

FIG. 2 is a schematic showing how a swivel of this invention is used.

FIG. 3 is a half section of a swivel of this invention.

FIG. 4 is a partial section of the swivel of this invention showing a spiral thread in one of the circulation ports.

Section. “A-A” of FIG. 4 is an end view of the circulation port of FIG. 4.

FIG. 5 is a partial section of the swivel of this invention showing a spiral thread insert in one of the circulation ports.

Section “B-B” of FIG. 5 is an end view of the circulation port of FIG. 5.

FIG. 6 is a partial section of the swivel of this invention showing a spiral thread insert with a broached hole in one of the circulation ports.

Section “C-C” of FIG. 6 is an end view of the circulation port of FIG. 6.

FIG. 7 is a partial section of the swivel of this invention showing a porous sintered metal insert insert in one of the circulation ports.

Section “D-D” of FIG. 7 is an end view of the circulation port of FIG. 7.

### DETAILED DESCRIPTION OF THE INVENTION

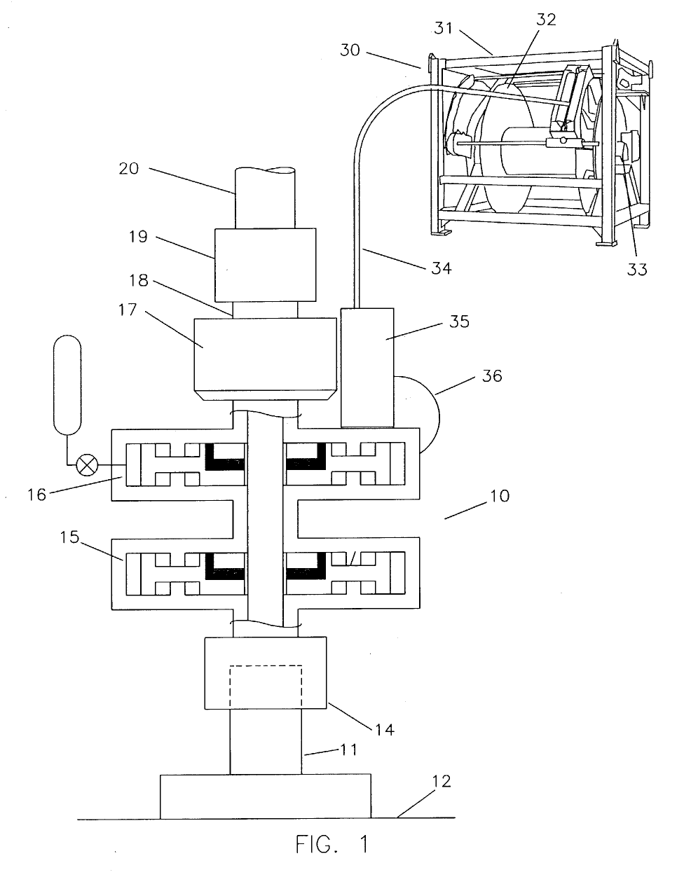

Referring now to FIG. 1, a blowout preventer (BOP) stack 10 is landed on a subsea wellhead system 11, which is supported above mudline 12. The BOP stack 10 is comprised of a wellhead connector 14 which is typically hydraulically locked to the subsea wellhead system 11, multiple ram type blowout preventers 15 and 16, an annular blowout preventer 17 and an upper mandrel 18. A riser connector 19, and a riser 20 to the surface are attached for communicating drilling fluids to and from the surface.

Reel 30 has a frame 31, spool 32, and a swivel 33 mounted on the central shaft of the spool (not shown). Hose and/or cable reel 34 is shown going from the spool 32 of the reel 30 to a control box 35 on the subsea blowout preventer stack 10. From the control box 35, appropriate hoses 37 go to control various functions, such as ram blowout preventer 16.

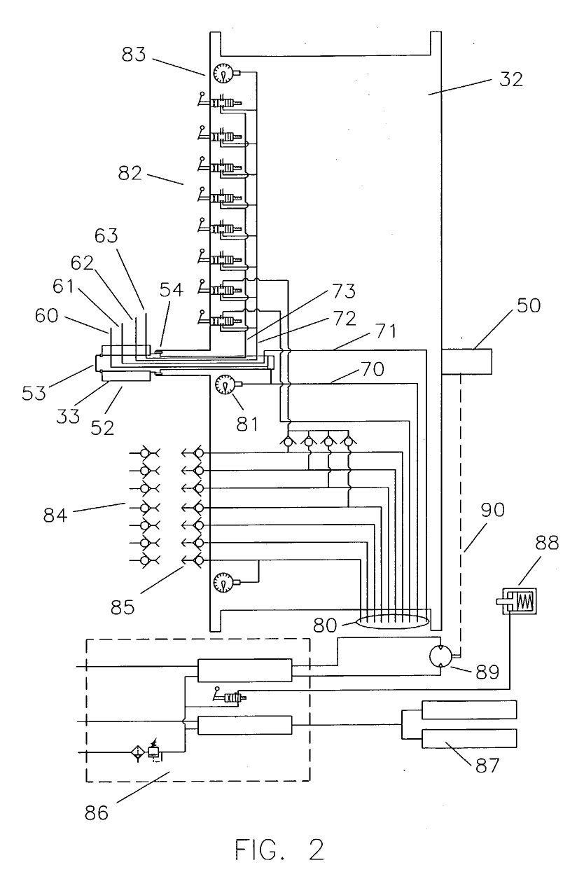

Referring now to FIG. 2, a reel schematic is shown. Spool 32 is shown mounted on the central shaft 50 which is supported by conventional bearings (not shown). On the left end of the central shaft 50 is mounted a swivel 33 having an outer body 52 and a mandrel 53. connection 54 attaches the swivel 51 to central shaft 50.

Hydraulic lines 60-63 are attached to the swivel outer body 52 to deliver pressurized fluids to the swivel from the non-rotating hydraulic supply (not shown). Within the spool, line 70 connects with line 60 and exits the main shaft 50 and goes directly to the hose bundle 80 going to the ocean floor. This line is characteristic of the lines which need the pressure to be maintained during the rotating operations. Gage 81 is provided on this line to monitor the pressure in this line. Line 71 connects with line 61 and also goes directly to the hose bundle and is characteristic of a return line which would not require the high pressure during rotation. Line 72 and 73 connect with lines 62 and 63 respectively and supply a multi-valve panel 82 on the side 83 of the spool 32 for individual control of a multiplicity of lines to subsea equipment.

Stab Plate 84 engages receptacle plate 85 to give individual hydraulic supply to various selected lines when the reel is not rotating. Control box 86 provides for operational control of the spool 32, failsafe brakes 87 provide stopping power for the spool 32, locking pin 88 provides positive position stopping for the spool 32, and motor 89 provides operations power for the spool 32.

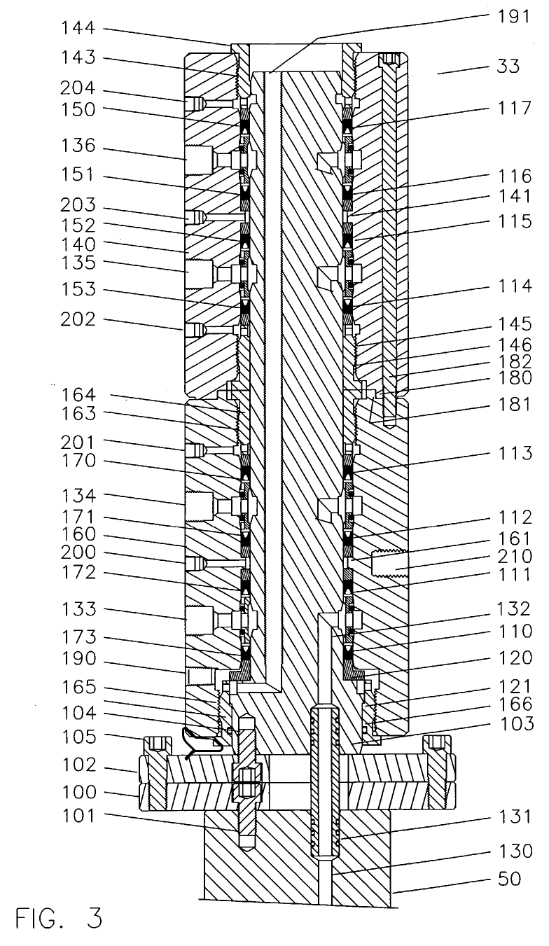

Referring now to FIG. 3, a half section of the swivel of this invention can be seen. Inner mounting plate 100 is attached to the main shaft 50 by bolts 101. Outer mounting plate 102 is mounted to the mandrel 103 by bolts 104. Outer mounting plate 102 is attached to the inner mounting plate 100 by bolts 105.

Mandrel 103 is an cylindrical member with 8 seal surfaces 110-117 and locating shoulders 120 and 121. Fluid pressure communicates thru port 130, thru seal sub 131, drilled hole 132, and out port 133. Similar flow paths occur in ports 134,135 and 136 at 90 degree spacings around the mandrel 103.

Body 140 provides a central locating shoulder 141, and end thread 143 which engaged by a gland 144, and an end thread 145 which is engaged by gland 146. The space between the central locating shoulder 141 and the glands 144 and 146 provides cavities for the insertion of seals 150 and 151 on one end and 152 and 153 on the other end. This provides that when high pressure is in the area between these seals, the outward force is directed by an appropriate shoulder or gland to resist the force. By providing the threaded gland design, seals made of hard plastic like material are able to be installed to give superior wear life with respect to soft seals which can be inserted into grooves.

Similarly, Body 160 provides a central locating shoulder 161, and end thread 163 which is engaged by a gland 164, and an end thread 165 which is engaged by gland 166. The space between the central locating shoulder 161 and the glands 164 and 166 provides cavities for the insertion of seals 170 and 171 on one end and 172 and 173 on the other end. This provides that when high pressure is in the area between these seals, the outward force is directed by an appropriate shoulder or gland to resist the force.

In this way each of 2 bodies has provided a central shoulder and a gland on each end to trap 2 sets of seals each, for a total of 4 sealed ports. The mandrel 103 has been made from a single piece of metal and provides a straight continuous flow path for the porting. The outer body is not continuous but is rather made of 2 independent bodies 140 and 160. Mating shoulders 180 and 181 keep the bodies 140 and 160 accurately aligned and bolts 182 keep them attached together for rotary operation. In this way we can install four sets (pairs) of seals which are not amenable to deforming and insertion into grooves. This allows a single swivel to have 3, 4, or more channels of high pressure service.

Port 190 is an air inlet port which can be used to flow air thru port 191 to allow for cooling of the internal portion of the mandrel 103. Ports 200-204 provide for leak detection from the seals. Thread 210 provides for an anti-rotation means to stop the rotation of the bodies while the mandrel is being rotated.

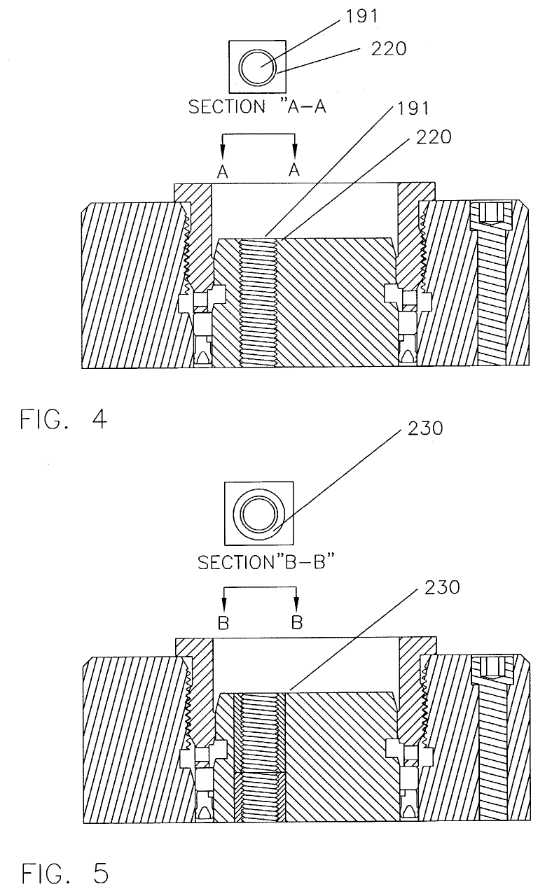

Referring now to FIG. 4, the cooling hole 191 has a spiral cut such as with a unified national V thread profile. The depth of the V grooves at 30 degrees will approximately double the metal to air interface for the transfer of the heat from the metal base to the air coolant. Air is the most logical coolant to use as when it is expelled out of the end of the swivel, there is no need to capture the exhausted air. Other medium such as water can be used but would normally require both supply and return plumbing. In addition to the benefit of greater surface area for transferring the heat from the mandrel to the air, the spiral will tend to cause the air to spin and in some cases will cause some turbulence in the air. Smooth laminar flow is not as efficient as tumbling turbulent air for the carrying away from the heat.

Section “A-A” is an end view of the circulation hole of FIG. 4.

Referring now to FIG. 5, a similar design is shown, except that the thread type profile is not cut into the base metal, sometimes requiring an extremely deep tapping operation on multi-channel swivels. In this case a slightly larger hole is drilled and then a series of short internally threaded sleeves 230 are pressed or glued in place.

Section “B-B” is an end view of the circulation hole of FIG. 5.

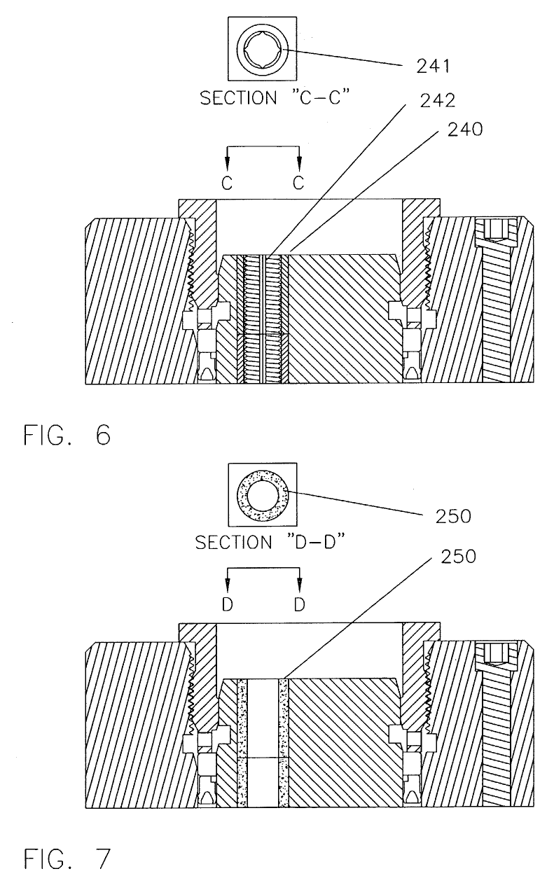

Referring now to FIG. 6, a design similar to FIG. 5 is shown, except that notches 241 are shown in the threaded profile 242 in the internally threaded sleeve 240. In this case a square broach of an appropriate size is pushed through the threaded profile to give 4 notches at approximately 90 degrees. These notches w ill tend to break up the flow and contribute to the turbulence mixing and therefore efficiency of heat transfer.

Section “C-C” is an end view of the circulation hole of FIG. 6.

Referring now to FIG. 7, an alternate style is shown with a hole drilled and then a set of porous sintered metal inserts 250 are inserted. The porous material will be intimate contact with the base material of the mandrel, and will communicate the heat through the porous material at the heat transfer rate of that material. Being adequately porous, the air will flow thru the porous material and have substantial extra contact areas to receive heat.

Section “D-D” is an end view of the circulation porous material of FIG. 7. Other combinations of spirals, notches, porous materials and similar method can be used to enhance the heat transfer efficiency of this system.

The foregoing disclosure and description of this invention are illustrative and explanatory thereof, and various changes in the size, shape, and materials as well as the details of the illustrated construction may be made without departing from the spirit of the invention.

I claim:

1. A swivel for the rotary connection of a fluid passageway from a non-rotating location to a rotating location, comprising
an outer body having one or more fluid inlet ports and having one or more cooling fluid ports,
a mandrel having one or more fluid passages and one or more cooling passages,
two or more seals sealing between said outer body and said mandrel which generate heat due to the sliding motion between said seal and said mandrel or said seal and said outer body,
said cooling passage for communicating a cooling medium thru said mandrel,
said cooling passage having a cross section area and having heat transfer surfaces to communicate said heat from the materials of said mandrel to said cooling fluid,
said heat transfer surface area being greater than the heat transfer surface area that would be provided by a cylindrical passage of the same cross section area.

2. The invention of claim 1, wherein a portion of said heat transfer surface is in the form of a spiral.

3. The invention of claim 1, wherein a notch is cut in the said spiral to cause turbulence in the flow of said cooling medium to improve the heat transfer characteristics.

4. The invention of claim 2, wherein said spiral is made by tapping an internal thread profile.

5. The invention of claim 1, wherein a portion of said heat transfer surface is in the form of a spiral which is incorporated into the bore of one or more sleeves which are inserted into a round hole in said mandrel.

6. The invention of claim 1, wherein a portion of said heat transfer surface is in the form of one or more porous sleeves with an internal hole which are inserted into a round hole in said mandrel.

7. The invention of claim 1, wherein a portion of said heat transfer surface is in the form of one or more slots which are incorporated into the bore of said mandrel.

8. The invention of claim 7, wherein a portion of said heat transfer surface is in the form of one or more slots which are incorporated into the bore of one or more inserts which are inserted into a round hole in said mandrel.

9. In a reel for handling one or more hoses from an offshore floating facility such as a drilling vessel or a service vessel to subsea drilling or service equipment, a swivel with an internal cooling passage having a surface area for transferring seal friction generated heat from said swivel to a cooling medium,
said surface area being greater than the surface area of a circular hole of the same cross section area.

10. The invention of claim 9, wherein a portion of said heat transfer surface is in the form of a spiral.

11. The invention of claim 9, wherein a notch is cut in the said spiral to cause turbulence in the flow of said cooling medium to improve the heat transfer characteristics.

12. The invention of claim 10, wherein said spiral if made by tapping an internal thread profile.

13. The invention of claim 9, wherein a portion of said heat transfer surface is in the form of a spiral which is incorporated into the bore of one or more sleeves which are inserted into a round hole in said mandrel.

14. The invention of claim 9, wherein a portion of said transfer surface is in the form of one or more porous sleeves with an internal hole which are inserted into a round hole in said mandrel.

15. The invention of claim 9, wherein a portion of said heat transfer surface is in the form of one or more slots which are incorporated into the bore of said mandrel.

16. The invention of claim 15, wherein a portion of said heat transfer surface is in the form of one or more slots which are incorporated into the bore of one or more inserts which are inserted into a round hole in said mandrel.
